(19) United States
(12) Patent Application Publication
(10) Pub. No.: US 2008/0098234 A1
(43) Pub. Date: Apr. 24, 2008

(54) FAULT-CONTAINMENT AND/OR FAILURE DETECTION USING ENCRYPTION

(75) Inventors: Kevin R. Driscoll, Maple Grove, MN (US); Brendan Hall, Eden Prairie, MN (US); Michael Paulitsch, Columbia Heights, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/551,539

(22) Filed: Oct. 20, 2006

(51) Int. Cl. H04N 7/16; H04L 9/32; G06F 12/14; G06F 17/30; G06F 7/04; G06F 11/30; G06K 9/00; H03M 1/68; H04K 1/00; H04L 9/00

(52) U.S. Cl. 713/189; 726/26; 726/27

(57) ABSTRACT

In one embodiment, a method of processing a received unit of data received at a node comprises using a first key to determine if at least a portion of the received unit of data was encrypted using a key that is compatible with the first key. The method further comprises determining whether to take a fault-containment action based on at least in part whether at least a portion of the received unit of data was encrypted using a key that is compatible with the first key. The method further comprises, when at least some of the received unit of data is relayed to the second node, using a second key to encrypt at least a portion of the received unit of data that is relayed to the second node in order to generate an encrypted version of the received unit of data that is relayed. The first key differs from the second key.

### BACKGROUND

Communication networks often include functionality for containing faults. Such fault-containment functionality, for example, prevents a faulty node in a network from transmitting on a communication medium at an inappropriate time. In this way, the fault within such a faulty node does not affect the operation of other nodes in the network by transmitting on the communication medium at an inappropriate time.

One example of fault-containment functionality is a bus guardian. Typically, when a bus guardian is used for a particular communication medium, any transmissions intended for the communication medium must pass through the bus guardian. That is, when a node wishes to transmit on the communication medium, the node transmits its data to the bus guardian, which receives the data and determines whether it is appropriate for that node to transmit on the communication medium at that time (for example, in accordance with a time-division multiple access (TDMA) protocol and/or other protocol or policy). If the bus guardian determines that it is appropriate for that node to transmit at that time, the bus guardian transmits the received data on the communication medium. If the bus guardian determines that it is not appropriate for that node to transmit at that time, the bus guardian does not transmit the received data on the communication medium. In this way the fault that caused the node to attempt to transmit at an inappropriate time is contained by the bus guardian.

Such a bus guardian typically includes at least one “input” to receive data from a node that wishes to transmit and an “output” for transmitting the received data on the communication medium if appropriate. However, the fault-containment features of the bus guardian can be defeated if the input and the output are shorted together (or are otherwise communicatively coupled to one another) such that any data received on the input is communicated on to the output and on to the communication medium via the short, regardless of the processing performed by the bus guardian. Such a short could be external to the bus guardian (for example, on the lines that couple a communication link to the bus guardian) or the bus guardian itself could be shorted internally (for example, within an integrated circuit that serves as the bus guardian's interface to the communication link). For example, where a faulty node attempts to transmit on the communication medium at an inappropriate time, the faulty node transmits the data to the bus guardian, where the data is received on the input of the bus guardian. The bus guardian does not transmit the received data on its output because it is not appropriate to do so. However, because the input and the output of the bus guardian are shorted to one another, the data received on the input from the faulty node is passed onto the output and the communication medium via the short in contravention of the bus guardian's attempt to prevent such a result.

Moreover, encryption schemes have been used to detect faults, such as shorts, between adjacent signal lines. One such scheme is described in U.S. Pat. No. 5,307,409, titled “APPARATUS AND METHOD FOR FAULT DETECTION ON REDUNDANT SIGNAL LINES VIA ENCRYPTION.” However, such fault-detection schemes are not designed to determine whether a fault exists that causes fault-containment functionality itself to fail in such a way that it no longer can provide its intended fault containment.

### SUMMARY

In one embodiment, a method of processing a received unit of data received at a node comprises using a first key to determine if at least a portion of the received unit of data was encrypted using a key that is compatible with the first key. The method further comprises determining whether to take a fault-containment action based on at least in part whether at least a portion of the received unit of data was encrypted using a key that is compatible with the first key. The method further comprises, when at least some of the received unit of data is relayed to the second node, using a second key to encrypt at least a portion of the received unit of data that is relayed to the second node in order to generate an encrypted version of the received unit of data that is relayed. The first key differs from the second key.

In another embodiment, a node comprises a first interface to communicatively couple the node to a first communication link. The node is operable to receive a received unit of data on the first communication link. The node further comprises a second interface to communicatively couple the node to a second communication link. The node is operable to transmit to a second node on the second communication link. The node further comprises fault-containment functionality. The node uses a first key to determine if the at least a portion of the received unit of data was encrypted using a key compatible with the first key. The fault-containment functionality determines whether to take a fault-containment action based on at least in part whether at least a portion of the received unit of data was encrypted using a key compatible with the first key. When the node relays at least some of the received unit of data to a second node, the node uses a second key to encrypt at least a portion of the received unit of data that is relayed to the second node in order to generate an encrypted version thereof. The first key differs from the second key.

In another embodiment, a network comprises a plurality of nodes. Each node is communicatively coupled to at least one node via at least one communication link. The plurality nodes comprise at least one terminal node and at least one guardian node that comprises fault-containment functionality used to determine whether a particular unit of data received that guardian node should be relayed. Each terminal node encrypts, using a respective output key, at least a portion of a unit of data that that terminal node transmits to another node. When the fault-containment functionality of the guardian node determines that the guardian node should relay a unit of data received at the guardian node, the guardian node encrypts at least a portion of the unit of data using a translation key in order to generate an encrypted version of the unit of data, the guardian node relaying the encrypted version of the unit of data. Each terminal node decrypts, using a respective input key, at least a portion of a unit data received at that terminal node to generate a decrypted version of the unit of data, that terminal node determining if the unit of data was encrypted using a key that is compatible with that terminal node's input key. Each terminal node's output key differs from the terminal node's input key.

The details of various embodiments of the claimed invention are set forth in the accompanying drawings and the description below. Other features and advantages will become apparent from the description, the drawings, and the claims.

### DRAWINGS

FIG. 1 is a block diagram of one embodiment of a node.

FIG. 2 is a flow diagram of one embodiment of a method of relaying data using encryption.

FIG. 3 is a block diagram of one embodiment of a network.

FIG. 4 is a block diagram of an alternative embodiment of a network in which the nodes of the network are arranged in a star topology.

Like reference numbers and designations in the various drawings indicate like elements.

### DETAILED DESCRIPTION

The systems, networks, devices, methods, and techniques described here can be implemented in various types of systems that implement, for example, various types of protocols (for example, a time-division multiple access (TDMA) protocol such as a time-triggered protocol such as TTP/C, SAFEbus, or FlexRay or the Institute of Electrical and Electronics Engineers (IEEE) 802.3 family of standards (also referred to as “Ethernet”) and various topologies (for example, rings, stars, chains, and/or buses topologies and topologies that make use of unidirectional and bi-directional communication links).

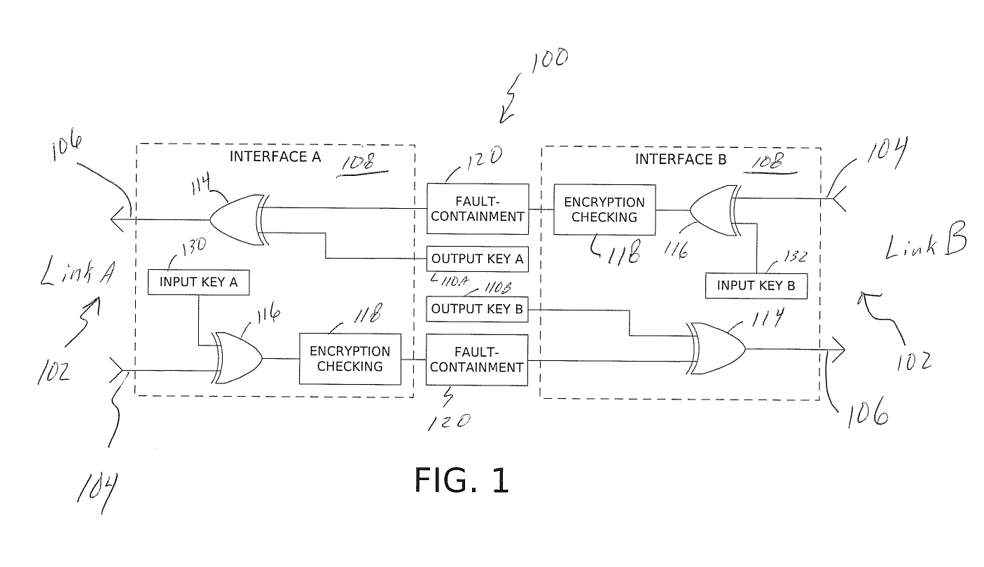

FIG. 1 is a block diagram of one embodiment of a node 100. In such an embodiment, the node 100 communicates data on multiple bi-directional communication links 102. In the particular example shown in FIG. 1, the node 100 communicates data on two bi-directional communication links 102, wherein one communication link 102 is individually referred to here as “link A” and the other communication link 102 is individually referred to here as “link B”. In one embodiment, the respective communication links 102 comprise one or more of wired communication links (for example, copper-wire links and/or fiber-optic links) and/or wireless communication links (for example, radio frequency (RF) or infra-red (IR) communication links).

At least some of the data that is transmitted by and received at the node 100 is encrypted. The node 100 comprises an interface 108 for each communication link 102 to which the node 100 is communicatively coupled. In the embodiment shown in FIG. 1, the node 100 comprises two interfaces 108, one of which is communicatively coupled to link A (and is referred to here individually as “interface A”) and the other of which is communicatively coupled to link B (and is referred to here individually as “interface B”). Each interface 108 comprises an incoming line 104 on which data is received at the node 100 and an outgoing line 106 on which data is transmitted from the node 100. The incoming line 104 of interface A is also referred to here as “incoming line A” or “input A”, and the incoming line 104 of interface B is also referred to here as “incoming line B” or “input B.” The outgoing line 106 of interface A is also referred to here as “outgoing line A” or output A”, and the outgoing line 106 of interface B is also referred to here as “outgoing line B” or “output B.”

In the particular embodiment shown in FIG. 1, when interface A is to transmit data on link A, interface A encrypts the data with a first key 110A (also referred to here as the “output key A” 110A). Also, when interface B is to transmit data on link B, interface B encrypts the data with second key 10B (also referred to here as the “output key B” 110B). In this embodiment, out key A and output key B are different from one another. In such an embodiment, each of the output keys 110A and 110B comprises a different predetermined bit pattern. For example, in one implementation, each output key 110A and 110B comprises a different fixed-length, predetermined bit pattern. In another implementation, each output key 110A and 110B is generated using a linear feedback shift register that generates a continuous bit stream using a predetermined seed value and polynomial for the linear feedback shift register. In other embodiments, each output key 110A and 110B is implemented in other ways.

In the embodiment shown in FIG. 1, both interface A and interface B comprise an XOR gate 114, where the output XOR gate 114 included in interface A is referred to here individually as “output XOR gate A” and the output XOR gate 114 included in interface B is referred to here individually as “output XOR gate B”. Interface A encrypts data by XOR'ing each bit of the data to be transmitted on link A with a corresponding bit from output key A. The output of the output XOR gate A is the encrypted data and is transmitted on the outgoing line 106 of interface A. Likewise, interface B encrypts data by XOR'ing each bit of the data to be transmitted on link B with a corresponding bit from output key B. The output of the output XOR gate B is the encrypted data and is transmitted on the outgoing line 106 of interface B.

Also, in such an embodiment, the node 100 expects that all data received at node 100 on link A to be encrypted with a third key 130 (also referred to here as “input key A”) and expects that all data received at node 100 on link B to be encrypted with a fourth key 132 (also referred to here as “input key B”). In this embodiment, input key A and input key B are different from one another and from output keys A and B and can be implemented in the same manner as the output keys A and B. In the embodiment shown in FIG. 1, both interface A and interface B comprise an XOR gate 116, where the input XOR gate 116 included in interface A is referred to here individually as “input XOR gate A” and the input XOR gate 116 included in interface B is referred to here individually as “input XOR gate B”. Both interface A and interface B comprise encryption-checking functionality 118, where the encryption-checking functionality 118 included in interface A is referred to here individually as “encryption-checking functionality A” and the encryption-checking functionality 118 included in interface B is referred to here individually as “encryption-checking functionality B”.

In the embodiment shown in FIG. 1, the node 100 further comprises fault-containment functionality 120 (for example, bus guardian functionality) that is operable to perform one or more fault-containment actions. When the node 100 is operating in a mode in which the node 100 relays data from link A to link B and/or from link B to link A, the fault-containment functionality 120 determines if such a relay operation should be performed for each unit of data (for example, each message or frame) received by the node 100. In one implementation of the embodiment shown in FIG. 1, the fault-containment functionality 120 does not relay improperly encrypted data that is received by one of the interfaces 108 (as determined by the encryption-checking functionality 118 included in each interface 108). In other words, in such an implementation, the fault-containment functionality 118 takes the fault-containment action of preventing the improperly encrypted data from being relayed on to another node. In another implementation, the fault-containment functionality 120 takes other fault-containment actions (for example, marking the improperly encrypted data that is received by one of the interfaces 108 to indicate that fact and then relaying the data).

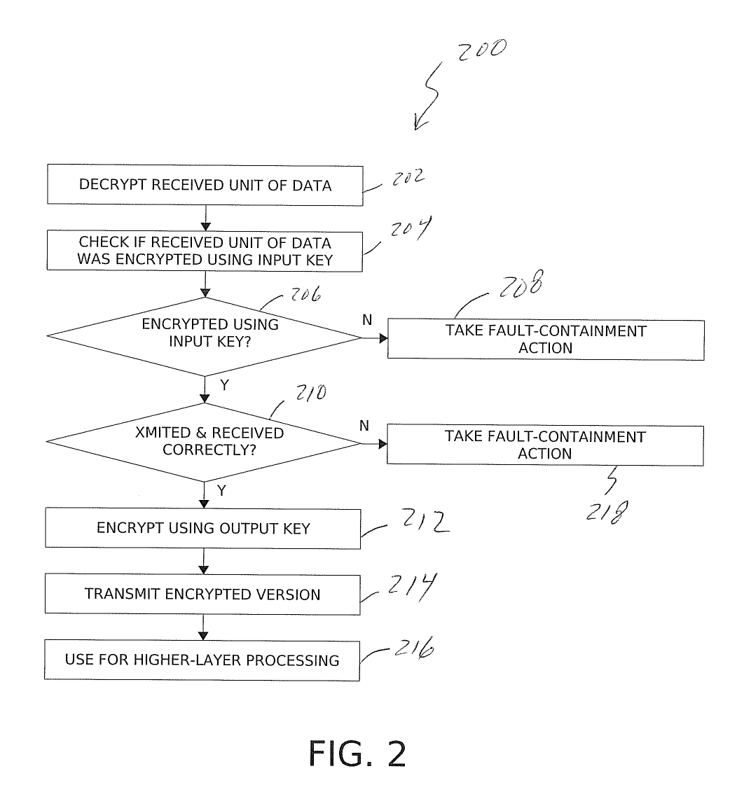

FIG. 2 is a flow diagram illustrating one embodiment of a method 200 of relaying data using encryption. The embodiment of method 200 shown in FIG. 2 is described in connection with the operation on node 100 of FIG. 1 when the node 100 is operating in a mode in which the node 100 relays data from link A to link B and/or from link B to link A (though it is to be understood that other embodiments can be implemented in other ways). The following description of method 200 refers to operation on particular units of data (such as a message or frame of data). It is to be understood, however, that such processing can also be performed relative to a portion of such a unit of data and/or on other units of data.

Method 200 is performed when node 100 receives a unit of data on the incoming line 104 of interface A. When this occurs, node 100 decrypts the received unit of data using the input key (block 202). In particular, the input XOR gate A is used to XOR each bit of the received unit of data with a corresponding bit from input key A. The output of the input XOR gate A should be the plain-text version of the received unit of data (if the received unit of data was actually encrypted using input key A). The encryption-checking functionality A uses the plain-text version of the received unit of data to check if the received unit of data was actually encrypted using a key that is compatible with the input key A (block 204). A key is compatible with the input key if the input key can be used to successfully decrypt data that was encrypted using that key and the relevant encryption scheme. In this particular embodiment where symmetric encryption is used, the encryption-checking functionality A uses the plain-text version of the received unit of data to check if the received unit of data was actually encrypted using the input key A. In other embodiments, asymmetric encryption is used. For example, where public key infrastructure (PKI) encryption is used, the private key used to encrypt data is compatible with the corresponding public key that can be used to decrypt that encrypted data.

Moreover, in one implementation of such an embodiment, the plain-text version of the unit of data that is encrypted and transmitted by a non-faulty node will include a predetermined field (for example, located in a preamble, header, or Frame Check Sequence) in which a predetermine or determinable value is stored. The encryption-checking functionality A looks for the predetermined or determinable value in the predetermined field of the plain-text version of the received unit of data. If the predetermined or determinable value is there, then the encryption-checking functionality A considers the received unit of data to have been encrypted by the transmitting node using a key that is compatible with the input key A. Such unit of data is also referred to here as a “properly encrypted” unit of data. If the predetermined or determinable value is not there, then the encryption-checking functionality A does not consider the received unit of data to have been encrypted by the transmitting node using a key that is compatible with the input key A. Such data is also referred to here as an “improperly encrypted” unit of data. For example, if the transmitting node encrypted a plain-text version of the received unit of data using a key other than a key that is compatible with the input key A, then decrypting the received unit of data with input key A will not result in the proper plain-text version of the received unit of data (that is, it will not result in the plain-text version of the received unit of data that was encrypted by the transmitting node using the other key). Typically, this results in a value other than the predetermined or determinable value being stored in the predetermined field. In other implementations, the determination as to whether the received unit of data was actually encrypted using a key that is compatible with the input key A is made in other ways such as by comparing the plain-text data to similar plain-text data received via another link. Interface B processes data received on the incoming line 104 of interface B in the same way using the input XOR gate B and the input key B. In one implementation, each interface 108 includes appropriate delay elements or other functionality to keep each of the input keys 130 and 132 synchronized to the data received on the respective interface 108.

The encryption-checking functionality 118 of node 100 checks if the received unit of data was properly encrypted data (block 206). If the received unit of data was not properly encrypted, the fault-containment functionality 120 of node 100 takes a fault-containment action (block 208). In one implementation of such an embodiment, the fault-containment functionality 120 causes the node 100 to not relay the received unit of data. If the received unit of data was properly encrypted, the fault-containment functionality 120 checks if the received unit of data with transmitted and received correctly (block 210). For example, in one implementation of such an embodiment, the node 100 implements a TDMA protocol in which each node in a network is scheduled to transmit during one or more time slots of a given TDMA round. In such an implementation, when a properly-encrypted unit of data is received, the fault-containment functionality 120 checks if it is appropriate for the transmitting node to transmit during the current time slot of the current TDMA round. If not, then the received unit of data would not be considered to have been transmitted correctly because the transmitting node was not scheduled to transmit at that time.

If the received unit of data was transmitted and received correctly, the fault-containment functionality 120 considers the plain-text version of the received unit of data to be valid data and permits the plain-text version of the received unit of data to be relayed from one link 102 to the other link 102. The plain-text version of the received unit of data is relayed by encrypting (block 212) and transmitting such unit of data as described above (block 214). Also, the plain-text version of the received unit of data is also used by any higher-layer processing performed by the node 100 (for example, by application software executing on a programmable processor included in the node 100) (block 216). If the received unit of data was not transmitted and received correctly, the fault-containment functionality 120 does not consider the plain-text version of the received unit of data to be valid and takes a fault-containment action (block 218). In one implementation of such an embodiment, the fault-containment functionality 120 causes the node 100 to not relay the received unit of data from one link 102 to the other link 102. In such a case, the plain-text version of the received unit of data is not used by any higher-layer processing performed by the node 100.

In other embodiments, other fault-containment actions are taken by the fault-containment functionality 120. For example, in one such alternative embodiment, a node 100 may relay (and/or use for higher-layer processor) some or all of the improperly encrypted unit of data but flag or mark that unit of data as not be trusted (or otherwise indicate that the unit of data was improperly encrypted or not transmitted and received correctly, for example, by modifying the unit of data or adding data to the unit of data).

Other embodiments can detect shorts through or around the fault-containment functionality 120 by comparing a suitably decrypted signal from an incoming line 104 (for example, the input to the fault-containment functionality 120) with a suitably decrypted signal from the corresponding outgoing line 106 (for example, the output of the respective output XOR gate subsequently XORed a second time with the output key) and determining that a short has occurred if this comparison does not match the value expected for a correctly behaving fault-containment functionality 120. For example, some of the most common designs of fault-containment functionality 120 have at their core a simple AND gate and an Enable signal. Thus, a representative equation for the transformation of a signal from an incoming line 104 to a corresponding outgoing line 106 would be:

Output_{—}B=((Input_{—}A⊕Input_Key_{—}A) AND Enable)⊕Output_Key_B

To monitor for shorts through or around the fault-containment functionality 120, one or both of the following logic equations could be used:

Check_Enable_On=(Output_{—}B⊕Input_{—}A)⊕(Input_Key_{—}A⊕Output_Key_{—}B)⊕1

Check_Enable_Off=(Output_{—}B⊕1)⊕Output_Key_B.

followed by the use of one or both of:

Short_Detected=Check_Enable_On⊕Enable

Short_Detected=Check_Enable_Off⊕Not Enable.

Check_Enable_On should have the logic value True when Enable is on (that is, True) and there is no short through or around the fault-containment functionality 120. Check_Enable_Off should have the logic value True when Enable is off (that is, False) and there is no short through or around the fault-containment functionality 120. Note that the order of evaluation in each check equation is purposely different from the order of evaluation in the transformation equation to preclude any commonality between them. When using hardware synthesis tools to create an implementation of these equations, the resulting logic should be checked to ensure that no gates are shared between the transformation functionality and the check functionality.

It is to be understood that the embodiments shown in FIG. 1 and FIG. 2 are exemplary and that other embodiments are possible. When an encrypted unit of data received on interface A (Encrypted Input A) is to be relayed on interface B, the following occurs:

Plain Text=Encrypted Input A⊕Input Key A

Encrypted Output B=Plain Text⊕Output Key B

Which is equivalent to:

Encrypted Output B=Encrypted Input A⊕Input Key A⊕Output Key B

For example, in one alternative embodiment, to reduce the delay between input and output, the plaintext version of the input unit of data is not used for relaying or for checking if the received data was encrypted using a particular key; instead, a first translation key is stored at a node that is equal to the input key A XOR'ed with output key B and a second translation key is stored at the node that is equal to the input key B XOR'ed with output key A. Then, when encrypted unit of data received on interface A (Encrypted Input A) is to be relayed on interface B, any encrypted unit of data received on interface A is XOR'ed with the first translation key. That is:

Encrypted Output B=Encrypted Input⊕First Translation Key

### Likewise, when any encrypted unit of data received on interface B is to be relayed on interface A, the encrypted unit of data received on interface B is XOR'ed with the second translation key.

The various components node 100 (including without limitation the XOR gates) can be implemented in hardware, software, and combinations thereof.

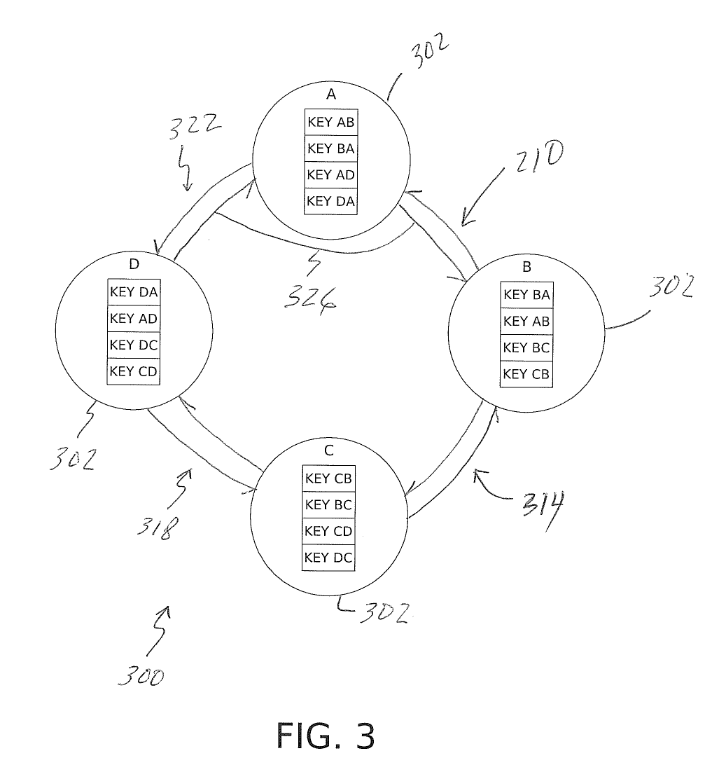

FIG. 3 is a block diagram of one embodiment of a network 300. The network 300 comprises a plurality of nodes 302, each of which is individually labeled as “node A”, “node B”, “node C”, or “node D”. Each of the plurality of nodes 302 comprises a node 100 of FIG. 1. The nodes 302 are arranged in a ring topology. Each of the plurality of nodes 302 are coupled to each of its two neighbor nodes over a single communication link (though it is to be understood that in other embodiments, multiple communication links are provided between each of the nodes). In the embodiment shown in FIG. 3, node A and node B are communicatively coupled to one another over a communication link 310. Node B and node C are communicatively coupled to one another over a communication link 314. Node C and node D are communicatively coupled to one another over a communication link 318. Node D and node A are communicatively coupled to one another over a communication link 322. Node A uses a “key AD” and “key AB” as its output keys, node B uses “key BA” and “key BC” as its output keys, node C uses a “key CB” and “key CD” as its output keys, and node D uses “key DC” and “key DA” as its output keys. Node A uses key DA as an input key for each unit of data received from node D and uses key BA as an input key for each unit of data received from node B. Node B uses key AB as its input key for each unit of data received from node A and uses key CB as its input key for each unit of data received from node C. Node C uses key BC as its input for each unit of data received from node B and key DC as its input key for each unit of data received from node D. Node D uses key CD as its input key for each unit of data received from node C and uses key AD as its input key for each unit of data received from node A.

In the example shown in FIG. 3, a short 326 exists between the incoming line 104 of interface A of node A and the outgoing line 106 of interface B of node A. Data transmitted from node D to node A on the communication link 322 is received on incoming line 104 of interface A of node A. However, the short 326 couples the incoming line 104 of interface A of node A to the outgoing line 106 of interface B of node A, which causes data received on that incoming line 102 to be communicated to node B via communication link 310 regardless of whether the fault-containment functionality 120 of node A decides to relay such data or not.

Where node D has a fault that causes node D to transmit a unit of data to node A at an inappropriate time (for example, where node D has a fault that causes node D to be a “babbling idiot”), interface B of node D will encrypt and transmit the unit of data on the communication link 322 using key D in the manner described above in connection with FIG. 1. The encrypted unit of data will be received at interface A of node A. Interface A of node A decrypts the received unit of data using key DA and confirms that the received unit of data was properly encrypted. However, because it is not appropriate for node D to transmit at that time, the received unit of data is not considered valid data and the fault-containment functionality 120 of node A does not relay the received unit of data on to node B. However, because of the short 326, the unit of data transmitted by faulty node D is communicated from the incoming line 104 of interface A of node A to the outgoing line 106 of interface B of node A where it is communicated to node B on communication link 310, despite the decision by the fault-containment functionality 120 of node A to not relay the received unit of data.

When node B receives on its interface A the unit of data initially transmitted by node D, the received unit of data is decrypted using key AB by node B. However, the encryption-checking functionality 118 of node B will determine that the received unit of data was not encrypted using key AB (because it was encrypted at node D using key DA). As result, the received unit of data will not be considered a properly encrypted unit of data and will not be relayed to node C or used by node B for higher-layer processing performed by node B. In this way, such a short fault can be contained.

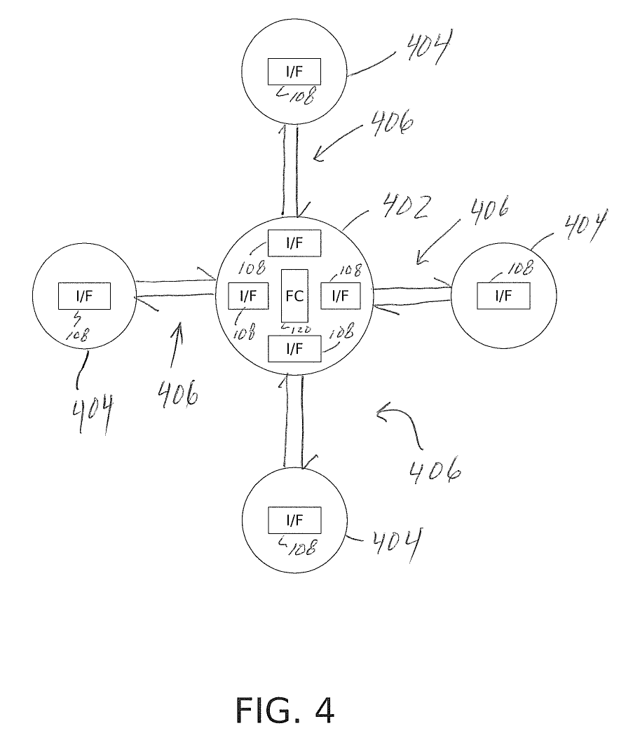

The systems, devices, methods, and techniques described here may be implemented in other ways in other embodiments. For example, other network topologies can be used, such as star topologies and braided-ring topologies. FIG. 4 is a block diagram of an alternative embodiment of a network 400 in which the nodes of the network are arranged in a star topology. In the embodiment shown in FIG. 4, the network 400 comprises a central bus-guardian node 402 and four leaf nodes 404 (also referred to here as “terminal” nodes 404). Each leaf node 404 is communicatively coupled to the bus-guardian node 402 over a respective bi-directional communication link 406 (which is similar to the communication links 102 described above in connection with FIG. 1). The bus-guardian node 402 is implemented in a similar manner as node 100 of FIG. 3 except that bus-guardian node 402 comprises four interfaces 108. The leaf nodes 404, in the embodiment shown in FIG. 4, each include an interface 108 of the type described above in connection with FIG. 1 for communicating over the respective communication link 406. However, each leaf node 404 does not include fault-containment functionality 120 and does not relay data received from the respective communication link 406. Instead, the encryption-checking functionality 118 included in the respective interface 108 of each leaf node 404 determines if received data was properly encrypted. If received data was properly encrypted, the plain-text version of the received data is used for high-layer processing performed by that leaf node 404. If the received data was not properly encrypted, the plain-text version of the received data is not used for high-layer processing performed by that leaf node 404 (that is, is discarded) or is marked as not having been properly encrypted.

In one implementation of such an embodiment, the bus-guardian node 402 decrypts at least a portion of the data it receives using an appropriate input key, checks if the resulting plaintext version was encrypted using the input key, and then encrypts at least a portion of the plaintext version with an appropriate output key before relaying the encrypted data. In another implementation, the bus-guardian node 402 does not decrypt the data it receives (and, therefore, does not use a plaintext version of the received data for relaying or for checking if the received data was encrypted using a particular key); instead, in such an implementation, the bus-guardian node 402 encrypts the received encrypted data using a translation key as described above before relaying the encrypted data (which was encrypted using the translation key). The fault-containment functionality included in the bus-guardian node 402, in such an implementation, determines if a particular received unit of data should be relayed by determining if some condition or policy is met that is not dependent on whether the received unit of data was properly encrypted.

An example of a braided-ring topology in which the techniques described here can be employed is described in U.S. patent application Ser. No. 10/993,936, titled “SYNCHRONOUS MODE BROTHER'S KEEPER BUS GUARDIAN FOR A TDMA BASED NETWORK,” filed on Nov. 19, 2004, which is also referred to here as the “'936 application” and which is hereby incorporated by reference in its entirety.

In general, the number of keys that is used in a given system or network is dependent on the number of communication links going into a given node, the number of links going out of a given node, the points where link-to-link shorts are physically possible, or some combination (depending on the particular topology that is employed). For example, in a network that employs a braided-ring topology of the type described in the '936 application where the nodes are distributed (i.e. nodes are far enough apart that shorts between nodes that aren't nearest neighbors on a ring is physically impossible), each node would use four (4) keys and the network total could be as little as six (6) unique keys. In a network that employs a braided-ring topology of the type described in the '936 application nodes aren't sufficiently distributed, additional keys will be needed. The minimum number of keys needed in a given system or network can be determined from the chromatic index of graph coloring theory with the vertices taken as the network's nodes plus all points where link-to-link shorts are physically possible. The number of keys used in a given system or network may exceed the minimum number derived from graph theory. Having a number of keys in excess of the minimum required may be desirable to simplify implementation or to provide other benefits; for example, maintaining DC balance on the encrypted signals.

Although the link cryptographic techniques described in connection with FIGS. 1-4 are generally described as being used with various types of fault-containment functionality, such link encryption techniques can be used for other purposes. For example, as described in connection with the leaf nodes 404 shown in FIG. 4, the link cryptographic techniques described here can simply be used to detect whether there is short between two upstream links, without such detection being used in connection with performing fault-containment of the type described above. In another exemplary embodiment, a simple Ethernet hub is configured to relay signals the hub receives on first link by “refreshing” (that is, regenerating) the signals and thereafter transmitting the refreshed signal on a second link. As a part of such refreshing, the hub encrypts the received signal with a key associated with the second link so that any node that receives the refreshed signal transmitted by the hub is able to determine if that signal was properly encrypted or if the first and second links are shorted together.

In general, wherever signal lines from two different communication links are physically located near each other (where there is chance that a short between the two lines may occur), the data communicated over the two signal lines should be encrypted and decrypted using different keys. For example, it may be the case that signal lines that appear to be distantly separated in a logical diagram may actually be adjacent in a physical layout, in which case different keys should be used to encrypt and decrypt data that is communicated over those lines. To implement such a network, design rules can be defined that constrain the physical layout and/or the assignment of keys to provide the desired protection for the physical layout used. In other embodiments, failure detection using such cryptographic techniques is used for other purposes such as determining if cables have been connected to their proper termini.

The keys that are used by each node in a network can be assigned a priori. Alternatively, the nodes can engage in a key discovery process in order to determine which keys should be used. For example, in one implementation, the output key that is used by each node in a network is derived from an identifier associated with that node and an identifier associated with the interface with which that key is used. If each node in the network knows (or can learn) the identifier of each node and interface with which that node is able to communicate, that node can calculate a respective input key for communicating with each such other node. For example, where a ring topology is used in which the node identifiers are assigned sequentially and each node's interface A is coupled to another nodes interface B (where each node uses the same identifier for interface A and interface B), a given node can determine the identifier of its two neighbors by adding or subtracting one from its own node identifier (assuming each node knows the lowest and highest node identifiers in the network and account therefor) and using the appropriate interface A or interface B identifier.

In one such implementation, the bottom three bits of each node's identifier are used as the upper three bits of that node's output keys, with the fourth bit set to one bit value for that node's output key A and with the fourth bit set to the other bit value for that node's output key B. For rings of eight or less nodes, there would be no physical topology constraints. For rings of more than eight devices, there would be a physical layout constraint that no output signals from nodes with the same lower three bits in their identifier could be physically adjacent. Such a constraint typically should not be difficult to meet.

Although the embodiments shown in FIGS. 1-4 are described as encrypting the entirety of each message that is transmitted, it is to be understood that only a portion of each message is encrypted and decrypted in other embodiments. For example, one could encrypt only the first data byte of a message. This idea is based on the observation that shorts (even intermittent shorts) are long-term phenomenon compared to the time duration of a message (from beginning bit to ending bit). Thus, if a short exists or does not exist at the beginning of a message, the same state probably is true for the duration of the message. Such an approach is especially suitable for use to provide a coverage mechanism for latent faults where immediate detection is typically not needed. Using four bits as the encryption key (as noted above), two encryptions would be done for each byte. Encrypting only the first byte of a message would result in two encryptions being performed for each message. The benefit of such an approach is that parts of the message that may be difficult to encrypt need not be encrypted. These parts include, for example, unique message component markers (such as “out-of-band signaling” symbols) and fields of the message that are mathematically or logically manipulated as they pass through a relay node.

Moreover, it is to be understood that techniques described here can be used in with communication devices, methods, and networks that use “store-and-forward” techniques and communication devices, methods, and networks that do not use “store-and-forward.”

Other embodiments which require DC-balanced signaling can perform the encryption described by inverting known DC-balanced sequences according to bits in the key. For example, each data bit in Manchester encoding consists of the encoded bit pair 01 or the encoded bit pair 10. If the first key bit is XORed with the first encoded bit pair, the second key bit is XORed with the second encoded bit pair, and so on until the Nth key bit is XORed with the Nth encoded bit pair, DC balance is maintained. The same idea of encoding multiple bit sequences of the data stream with a single bit of a key can be applied to codes, such as 8B/10B, that are designed to minimize DC unbalance (disparity) rather than having all DC-balanced symbols. For these codes, the number of bits in the data stream that are encrypted for each key bit may not be a fixed number and the number may have to be determined dynamically.

Although keys are typically short (on the order of a nibble), some large, highly complex topologies that cannot have signal routing suitably constrained and could require large keys. Large keys combined with multiple-bit encryption (for example, to maintain DC balance) could require a large number of data bits to be encrypted in order to fully use all of the key bits (which is needed to ensure that all possible shorting fault scenarios are covered). If the number of data bits that need to be encrypted is larger than the message size, the message could be padded out to the required length; but, a more bandwidth efficient mechanism may be to reserve a field in the message. The data values that may be used in this field can be selected from those data values with the appropriate DC balance or disparity. The encryption, then, is restricted to this field and can be seen as a simple substitution with each data value having a correspondence with only one key. For encoding systems that allow for some DC balance disparity, a homophone for each allowed level disparity can be associated with a key.

Also, although the embodiments shown in FIGS. 1-4 are described as encrypting every message that is transmitted by a given node, in other embodiments, not all messages that are transmitted by a given node need to be encrypted. For example, which messages are encrypted and which are not could be determined according to a schedule, could be decided on-demand, or determined in other ways.

In one such embodiment, only special test messages are encrypted in this manner (for example, to detect shorts of the type described here) and the data that is encrypted and decrypted can be data that is not otherwise used (for example, a constant value such a zero).

In another embodiment, such encryption techniques are used when a node enters a test mode. One example of such a test mode is a test mode that implements at least a portion of the functionality specified in Institute of Electrical and Electronics Engineers (IEEE) 1149 “JTAG” boundary scan standard. Conventionally, a boundary scan is used to find opens and shorts in signal wires that would prevent proper operation of a device in the node. In one embodiment, such encryption testing is used, not to find opens and shorts that would prevent proper operation, but to find shorts between redundant signals that, in absence of another fault, would not cause improper operation.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs), complex programmable logic devices (CPLDs), or field programmable gate arrays (FPGAs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A method of processing a received unit of data received at a node comprising:
using a first key to determine if at least a portion of the received unit of data was encrypted using a key that is compatible with the first key;
determining whether to take a fault-containment action based on at least in part whether at least a portion of the received unit of data was encrypted using a key that is compatible with the first key; and
when at least some of the received unit of data is relayed to the second node, using a second key to encrypt at least a portion of the received unit of data that is relayed to the second node in order to generate an encrypted version of the received unit of data that is relayed;
wherein the first key differs from the second key.

2. The method of claim 1, wherein the fault-containment action comprises at least one of:
preventing the node from relaying, to a second node, less than the entire received unit of data;
preventing the node from relaying, to a second node, the entire received unit of data;
adding data to the received unit of data to indicate that the received unit of data was not properly encrypted using a key compatible with the first key; and
modifying at least a portion of the received unit of data to indicate that the received unit of data was not properly encrypted using a key compatible with the first key.

3. The method of claim 1, further comprising decrypting at least a portion of the received unit of data using the first key in order to generate a plain-text version of the received unit of data.

4. The method of claim 3, wherein the at least a portion of the received unit of data is decrypted using an XOR operation and the encrypted version of the received unit of data that is relayed is encrypted using an XOR operation.

5. The method of claim 1, further comprising determining whether the received unit of data was transmitted and received correctly, wherein the method further comprises determining whether to take a fault-containment action based at least in part on whether the received unit of data was transmitted and received correctly.

6. The method of claim 5, wherein the determination whether the received unit of data was transmitted and received correctly is made at least in part using a time-division multiple access protocol.

7. The method of claim 5:
wherein the determination whether the received unit of data was transmitted and received correctly is made by fault-containment functionality; and
wherein the method further comprises comparing at least a portion of a plain-text version of the received unit of data with at least a portion of a plain-text version of the data to be relayed in order to determine if a fault condition related to the fault containment functionality exists.

8. The method of claim 1, wherein at least some of the received units of data are relayed without regard to whether at least a portion of the respective received unit of data was encrypted using a key compatible with the first key.

9. The method of claim 1, wherein the method is performed during a test operation.

10. The method of claim 1, wherein at least one of symmetric encryption and asymmetric encryption is used.

11. A node comprising:
a first interface to communicatively couple the node to a first communication link, wherein the node is operable to receive a received unit of data on the first communication link; and
a second interface to communicatively couple the node to a second communication link, wherein the node is operable to transmit to a second node on the second communication link;
fault-containment functionality;
wherein the node uses a first key to determine if the at least a portion of the received unit of data was encrypted using a key compatible with the first key;
wherein the fault-containment functionality determines whether to take a fault-containment action based on at least in part whether at least a portion of the received unit of data was encrypted using a key compatible with the first key; and
when the node relays at least some of the received unit of data to a second node, the node uses a second key to encrypt at least a portion of the received unit of data that is relayed to the second node in order to generate an encrypted version thereof;
wherein the first key differs from the second key.

12. The node of claim 11, wherein the fault-containment functionality determines whether the received unit data was transmitted and received correctly, wherein the fault-containment functionality determines whether to take a fault-containment action based at least in part on whether the received unit data was transmitted and received correctly.

13. The node of claim 11, wherein the fault-containment action comprises at least one of:
preventing the node from relaying, to a second node, less than the entire received unit of data;
preventing the node from relaying, to a second node, the entire received unit of data;
adding data to the received unit of data to indicate that the received unit of data was not properly encrypted using a key compatible with the first key; and
modifying at least a portion of the received unit of data to indicate that the received unit of data was not properly encrypted using a key compatible with the first key.

14. A network comprising:
a plurality of nodes, wherein each node is communicatively coupled to at least one node via at least one communication link;
wherein the plurality nodes comprise at least one terminal node and at least one guardian node that comprises fault-containment functionality used to determine whether a particular unit of data received that guardian node should be relayed;
wherein each terminal node encrypts, using a respective output key, at least a portion of a unit of data that that terminal node transmits to another node;
wherein, when the fault-containment functionality of the guardian node determines that the guardian node should relay a unit of data received at the guardian node, the guardian node encrypts at least a portion of the unit of data using a translation key in order to generate an encrypted version of the unit of data, the guardian node relaying the encrypted version of the unit of data;
wherein each terminal node decrypts, using a respective input key, at least a portion of a unit data received at that terminal node to generate a decrypted version of the unit of data, that terminal node determining if the unit of data was encrypted using a key that is compatible with that terminal node's input key.
wherein each terminal node's output key differs from the terminal node's input key.

15. The network of claim 14, wherein at least a portion of the communication links comprise at least one of wired communication links and wireless communication links.

16. The network of claim 14, wherein at least a portion of the nodes are arranged in at least one of a star topology and a ring topology.

17. The network of claim 14, wherein multiple communication links communicatively couple each node to another node.

18. The network of claim 14, wherein the output key for each node is derived from an identifier associated with that node.

19. The network of claim 14, wherein at least a portion of the nodes perform key discovery processing in order to determine at least one of an output key and input key used by another node with which each of the portion of nodes communicates.

20. The network of claim 14, wherein the translation key is derived from an input key and output key associated with the guardian node.

21. The network of claim 21, wherein the translation key is generated by performing an exclusive OR operation on the input key and the output key associated with the guardian node.

22. The network of claim 14, wherein the fault-containment functionality determines whether the guardian node should relay a unit of data received at the guardian node in a manner that is not dependant on whether the unit of data was encrypted using a key that is compatible with the input key associated with the guardian node.
